(19) United States
(12) Patent Application Publication
(10) Pub. No.: US 2026/0047560 A1
(43) Pub. Date: Feb. 19, 2026

(54) SYSTEMS FOR TAKING CARE OF DOG

(71) Applicant: VISUAL EARTH LIMITED, San Po Kong (HK)

(72) Inventor: Shakira Renata Monique Twijsel, San Po Kong (HK)

(21) Appl. No.: 19/302,117

(22) Filed: Aug. 18, 2025

Related U.S. Application Data
(60) Provisional application No. 63/684,472, filed on Aug. 19, 2024.

(51) Int. Cl. A01K 29/00; A61D 99/00; H04L 51/046

(52) U.S. Cl. CPC A01K 29/007; A01K 29/004; A61D 99/00; H04L 51/046

(57) ABSTRACT

The present disclosure proposes a solution wherein a smart vest worn on dogs and a related system including the vest, a sever and a user device are used for discerning the dogs' mood and anxiety levels, and alleviate their distress e.g., when left alone at home. The solution may provide emotional monitoring, multi-sensory interaction, remote control and monitoring, customizable responses, and holistic wellbeing for the dogs.

### TECHNICAL FIELD

The present disclosure relates to a field of smart wearable devices, and in particular to systems for taking care of dog, which can discern their mood and anxiety levels, and alleviate their distress e.g., when left alone at home.

### BACKGROUND

In recent years, millions of people have adopted dogs as lifelong companions, prioritizing their pets' well-being. However, due to work commitments and busy schedules, many owners are frequently away from their pets for over six hours daily. Prolonged isolation can lead to heightened anxiety and an increased risk of depression in dogs. To address these issues, various devices have been developed to monitor canine behavior and facilitate remote interaction between dogs and their owners.

Those devices include: (1) Anxiety Vests (e.g., Thundershirt): these snug-fitting garments apply gentle pressure to a dog's torso, producing a calming effect akin to swaddling an infant; (2) Calming Collars (e.g., Adaptil): designed to release synthetic pheromones that mimic those naturally secreted by mother dogs to soothe their puppies; (3) Interactive Pet Cameras (e.g., Furbo): equipped with cameras and treat dispensers, enabling owners to observe and engage with their pets remotely; (4) Smart Pet Wearables (e.g., Whistle, FitBark): tracking vital health metrics such as heart rate, sleep patterns, and activity levels.

### SUMMARY

The inventors of the present disclosure find that the current devices for monitoring and interacting dogs have various disadvantages. In particular, the disadvantages of the current devices are listed below.

The disadvantages of Anxiety Vests include:
Limited to physical pressure only without any technological integration.
No real-time monitoring or response to the dog's emotional state.
Requires manual adjustment and cannot be controlled remotely.

The disadvantages of Calming Collars include:
Effects are not immediate and can vary significantly from dog to dog.
Limited to chemical release without any interactive features.
No way to monitor the effectiveness in real-time.

The disadvantages of Interactive Pet Cameras include:
Primarily focused on visual and treat-based interaction, lacking emotional monitoring.
Does not provide a calming physical presence to the dog.
Limited to stationary use and does not offer wearable comfort.

The disadvantages of Smart Pet Wearables include:
Primarily focused on health and activity tracking without direct interaction or emotional support.
Lack of features to actively calm or comfort the pet.
Limited to data tracking and analysis without real-time intervention capabilities.

To resolve or alleviate at least one of the above problems, the inventors of the present disclosure conceive of a solution wherein a smart vest, collar or harness worn on dogs and a related system including the vest, collar or harness, a user device and a sever are used for discerning the dogs' mood and anxiety levels, and alleviate their distress e.g., when left alone at home.

The first aspect of the solution provides a system for taking care of dog, comprising: a smart vest, worn on a dog; a user device, used by owner of the dog for remote interaction with the smart vest; and a server, communicating with the smart vest and the user device respectively to implement the remote interaction.

The second aspect of the solution provides a system for taking care of dog, comprising: a smart collar or harness, worn on a dog; a user device, used by owner of the dog for remote interaction with the smart collar or harness; and a server, communicating with the smart collar or harness and the user device respectively to implement the remote interaction.

The abovementioned user device may be a device specially developed and dedicated for the purpose of the present disclosure or a general-purpose device (such as a mobile phone, a desktop computer, a laptop computer, a tablet, and so on) with an application software (abbreviated as app thereafter) specially developed and dedicated for the purpose of this disclosure. The solution according to the present disclosure has no limitation in this regard.

In an embodiment of the system of the first aspect, to predict a dog's anxiety level, one or more physiological information sensors such as a heart monitoring sensor, a thermometer, a respiratory monitoring sensor, and/or oxygen lever monitoring sensor may be provided in the vest to track the dog's physiological information in real time. This information may be sent to the server via e.g., microprocessors and Wi-Fi modules. The data is then processed and analyzed using e.g., an AI model to obtain the dog's emotional status such as the anxiety level, which optionally along with the physiological information, may be sent to the owner's user device.

The owner can monitor their dog's anxiety through the user device. In an example, by pressing a button on the app, the owner can send a comforting “hug” to the dog. If the owner has a smartwatch monitoring his/her heartbeat, this data can also be transmitted to the dog via e.g., one or more vibrators integrated the vest, allowing the dog to sense the owner's heartbeat. Additionally, the vest may also include a speaker that enables the owner to talk to their dog, providing further comfort.

In sum, the solution of the present disclosure may have the following advantages:
Emotional Monitoring: Unlike existing products, the solution of the present disclosure uses e.g., advanced AI to monitor and respond to a dog's emotional state in real-time, providing a dynamic and responsive solution to anxiety and stress.
Multi-Sensory Interaction: the solution of the present disclosure offers a combination of gentle pressure, vibration, and sound, enhancing the calming effect and providing comprehensive support to the dog.
Remote Control and Monitoring: Owners can interact with and monitor their dog's emotional wellbeing through e.g., a mobile app, offering convenience and peace of mind even when they are away.
Customizable Responses: The solution of the present disclosure can learn and adapt to each dog's unique needs and preferences, by using e.g., AI, providing personalized care that is not possible with one-size-fits-all solutions.
Holistic Wellbeing: By addressing both emotional and physical health, the solution of the present disclosure offers a more complete approach to pet care, setting a new standard in the industry.

### BRIEF DESCRIPTION OF THE DRAWINGS

In order to better describe and illustrate the embodiments and/or examples of the contents disclosed herein, reference may be made to one or more drawings. Additional details or examples used to describe the drawings should not be considered as limiting the scope of any of the disclosed contents, the currently described embodiments and/or examples, and the best mode of these contents currently understood.

FIGS. 1-2 illustrate dogs wearing a vest according to the present disclosure.

FIGS. 3-6 illustrate an example vest according to the present disclosure along with various components which may be included in the vest.

FIG. 7 shows an example network implementing a connection between the vest and the app on a phone of the owner.

FIG. 8 shows example user interfaces of the app according to the present disclosure.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the drawings. However, the present disclosure can be implemented in many different forms and is not limited to the embodiments described herein. On the contrary, the purpose of providing these embodiments is to make the present disclosure more thorough and comprehensive.

Unless otherwise defined, all technical and scientific terms used herein have the same meaning as commonly understood by one of ordinary skill in the art to which this invention belongs. The definitions are provided to aid in describing particular embodiments, and are not intended to limit the claimed invention. The term “and/or” used herein includes any and all combinations of one or more related listed items.

In order to understand this application thoroughly, detailed components will be provided in the description below in detail to explain the technical solution proposed by this application. However, in addition to or as alternatives to these details, the solution of the present disclosure may be implemented with other components. In addition, it can be understood that, some components described below are optional in the solution of the present disclosure.

As described above, the first aspect of the solution provides a system for taking care of dog, comprising: a smart vest, worn on a dog; a user device, used by owner of the dog for remote interaction with the smart vest; and a server, communicating with the smart vest and the user device respectively to implement the remote interaction.

The user device may be a device specially designed and dedicated for the purpose of the present disclosure or a general-purpose device (such as a mobile phone, a desktop computer, a laptop computer, a tablet, and so on) with an app specially developed and dedicated for the purpose of this disclosure. The solution according to the present disclosure has no limitation in this regard.

In addition, the vest may be considered as being smart in view of its capabilities of communicating with the server and interacting with the user device.

In an embodiment, the smart vest comprises one or more physiological information sensors and multiple vibrators, wherein the dog's physiological information monitored by the one or more physiological information sensors is sent by the smart vest to the server for analyzing the dog's emotional status, and the remote interaction includes that the owner sends an instruction to the smart vest through the user device for activating one or more of the vibrators to simulate a hug of the owner, in view of the dog's emotional status received by the user device from the server, as described below.

In a further embodiment, the server comprises an AI module to analyze the dog's emotional status based on the dog's physiological information.

In a further embodiment, the one or more physiological information sensors comprise a heartbeat sensor, and the dog's physiological information comprises the dog's heartbeat information, and the dog's emotional status comprises the dog's anxiety level.

### The Vest and the Integrated Sensors

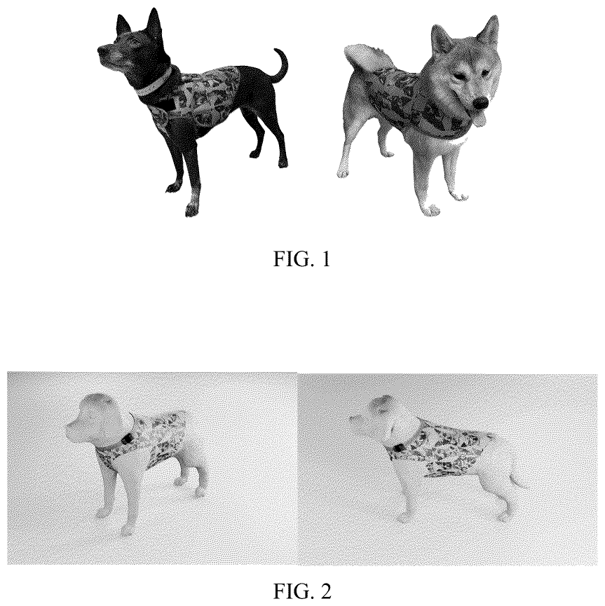

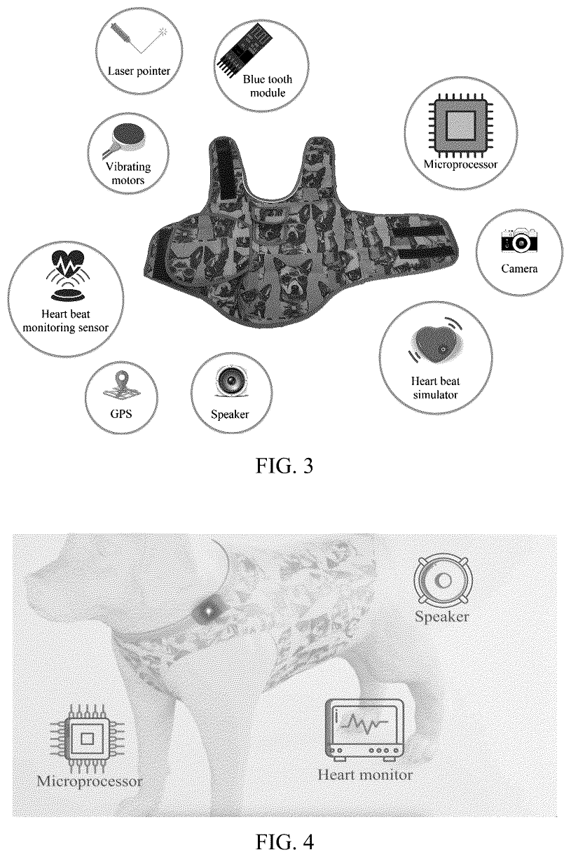

In an example, the vest may be designed with biocompatible material, ensuring comfort for dogs. FIG. 1 and FIG. 2 show dogs wearing the vest. For the purpose of the present disclosure, the vest may integrate various components, including e.g., heart monitoring sensors, GPS, laser pointer, camera, motors, a heartbeat simulator, a microprocessor, a speaker, and a Bluetooth module, as shown in FIGS. 3-6. The heartbeat sensor, which can be mounted on a collar or near the dog's heart, monitors the heartbeat accurately. An array of vibrator motors on the vest simulates the sensation of petting or hugging the dog. Additionally, a vibrator motor and a speaker may be included in the vest to simulate the owner's heartbeat and allow the owner to talk to the dog, providing comfort and reassurance.’

### Building Communication Between the Vest and the User Device

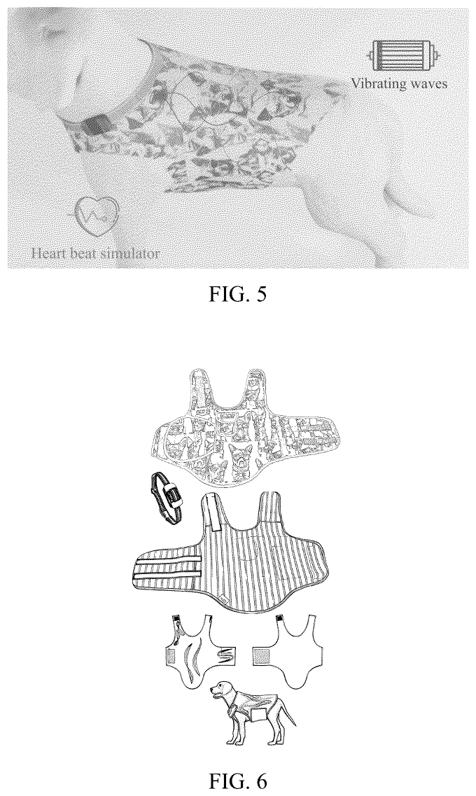

A server may be used to establish a connection between the vest and the user device, e.g., the phone of the owner with an app specially developed and dedicated for the purpose of the present disclosure. An example network implementing the connection is shown in FIG. 7. The data collected from the sensors integrated into the vest can be sent to the server in e.g., following two ways:
1. Direct Wi-Fi Connection: A Wi-Fi module connected to the microprocessor sends the data directly to the server.
2. Bluetooth to Wi-Fi Relay: Two separate microprocessors are used to send the data. The first microprocessor, fixed to the vest, sends the data to a second stationary microprocessor at home (similar to a Wi-Fi modem) via Bluetooth. The stationary microprocessor then sends the data to the server through a Wi-Fi module. This way helps to increase the vest's battery life.

It can be understood by persons skilled in the art that, in addition to the above two ways, the communication between the vest and the server may be implemented through many other ways, and the solution according to the present disclosure has no limitation in this regard. The same applies to the communication between the server and the user device.

Once the data is sent to the server, it can be monitored through the user device. Additionally, the user device can receive data from external devices like a smartwatch to monitor the owner's heartbeat.

In a further embodiment, the server comprises an AI module to analyze the dog's anxiety level based on the dog's heartbeat information.

### AI Mode to Predict the Emotional Status of the Dog

In an example, an AI model may be used in order to evaluate the stress and anxiety level of the dog. Also, the model may be able to classify different moods of the dog (happy, angry, anxious, etc.). The AI model may be trained e.g., in the server and the data will be analyzed, classified and predicted after passing through the trained model, in real time.

The output of the AI model may be in the server and presented in the user device. Also, after detecting high anxiety level, the owner may receive a notification so that he/she will be able to talk to the dog or send a hug (through the vest) to comfort his/her dog.

In a further embodiment, the smart vest comprises a heartbeat simulator, and the user device comprises a receiver for receiving the owner's heartbeat information from another device (such as a smartwatch worn by the owner and recording the owner's heartbeat information), wherein the owner's heartbeat information is sent by the user device to the smart vest via the server, in order for the smart vest to simulate the owner's heartbeat through one of the vibrators or the heartbeat simulator while simulating the hug of the owner.

In an embodiment, the smart vest comprises a speaker, and the remote interaction includes that the owner remotely operates the speaker through the user device to talk to the dog.

### Hugging Simulation and Heart Beat Transferring Mechanism

In an example, by pressing and holding a button on the user device, such as a button on Graphical User Interface (GUI) of the app (similar to WhatsApp), owners can talk to their dog in real time. The voice may be sent online to the vest, where the speaker plays it. Additionally, owners can send a “hug” to their dogs e.g., by pressing a button on the app. This command may be sent to the server, which then instructs the microprocessor to activate the vibrator(s) on the vest, simulating a hug for the dog. During this process, the owner's heartbeat may be also transmitted to the vest (thus to the dog), providing a natural and comforting hug experience for the dog.

In an embodiment, the smart vest comprises a laser pointer and a camera, and the remote interaction includes that the owner remotely operates the laser pointer and the camera through the user device to play the laser point with the dog.

Playing Laser Point with the Dog

In an example, the owners may also be able to connect to the vest and by controlling a laser in the vest which is controlled with a DC motor and play with their pets. The laser may be fixed with a DC motor being able to rotate laser point, also on top of the laser a camera may be placed so that the owner will be able to track the laser point and play with the dog. All these elements may be integrated inside a box, and the box may be fixed in the front of the vest (chest or neck of the dog).

In an embodiment, the smart vest comprises a location tracker (such as a GPS device), and the remote interaction includes that the smart vest sends the dog's location information recorded by the location tracker to the user device via the server.

### Tracking the Dog

In an example, by connecting e.g., a GPS to the vest and monitoring the dog's emotional status from the server (in particular, e.g., the AI model in the server) in real time by the user device, the owners will be able to see the favorite places or parks of their dogs and all location information will be recorded and sent to the user device, so that the owners will know everything about their pets, and thus the owners will be able to make their dogs happier by taking the dogs to the places they like the most. Moreover, an internal networking mechanism may be provided in a way that if two dogs both use the vest, one or more sensors including e.g., the GPS may collect all the data showing e.g., whether a dog loves to play with the other dog or not, which will help the owners to know each other and create a healthy and small community.

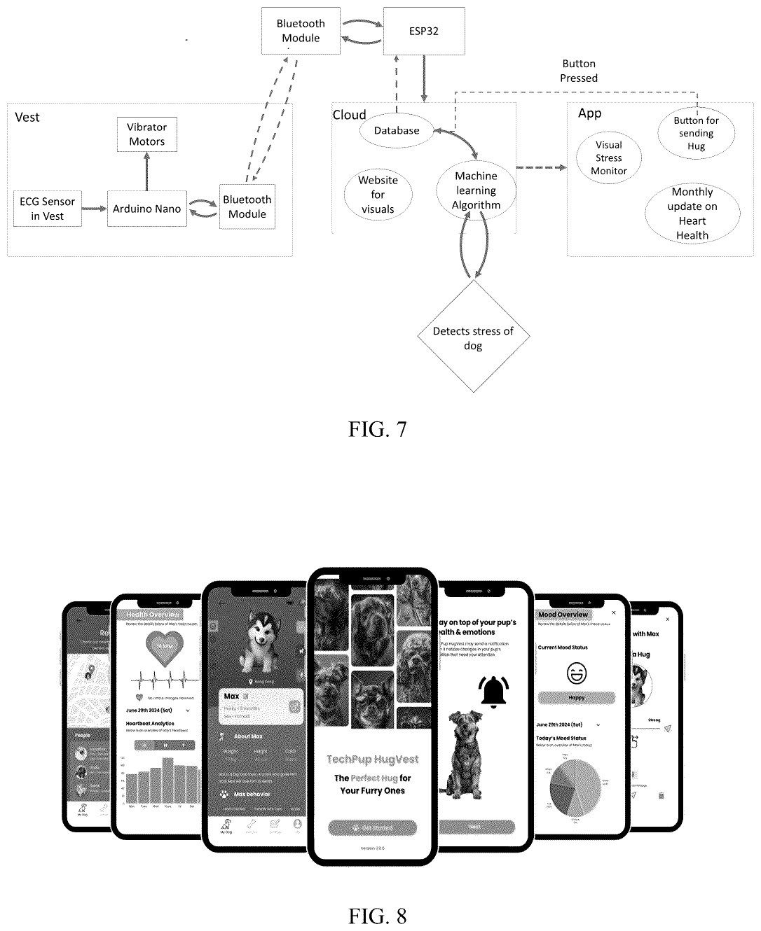

FIG. 8 shows example user interfaces of the app according to the present disclosure. The app may allow the owners to monitor their pets' mood and anxiety levels, send comforting hugs, and even talk to their pets. Additionally, if the owner wears a smartwatch, the app may record the owner's heartbeat and sends it to the heartbeat simulator integrated into the vest, allowing the dog to feel the owner's heartbeat for added comfort. Additionally, the app may enable the dog owners to connect with others in their vicinity, fostering friendships and building a vibrant dog community.

The second aspect of the present disclosure provides a system for taking care of dog, comprising: a smart collar or harness, worn on a dog; a user device, used by owner of the dog for remote interaction with the smart collar or harness; and a server, communicating with the smart collar or harness and the user device respectively to implement the remote interaction. Also, the user device may be a device specially designed and dedicated for the purpose of the present disclosure or a general-purpose device with an app specially developed and dedicated for the purpose of this disclosure. The solution according to the present disclosure has no limitation in this regard. In addition, the collar or harness may be considered as being smart in view of their capabilities of communicating with the server and interacting with the user device.

In an embodiment, the smart collar or harness comprises one or more sensors to monitor one or more of the following information: the dog's heart rate, oxygen level, body temperature, barking, activity status, and respiration, and the remote interaction includes that the smart collar or harness sends the information to the user device via the server.

In an example, the one or more sensor can monitor one or more of the following information:
Heart rate (e.g., by using ppg sensor-microphone-ultrasound-mm waves)
Oxygen level (e.g., by using ppg sensor)
Body temperature (e.g., by using thermometer)
Dog barking (e.g., by using IMU sensor and microphone)
Dog being active (e.g., number of steps, activity, etc. by e.g., using IMU sensor)
Respiration (e.g., by using a band integrated with harness or vest that measures amount of chest expansion)

In an example, all day the sensor that either is in collar around the neck or in harness around the belly, may measure the information mentioned above. In the user device, all the measured information is being monitored in real time and saved daily in e.g., an app, then the owner can monitor it in real time or check it as daily, weekly, or monthly activity.

In a further embodiment, the user device notifies the owner of an abnormality in the information in response to detection of the abnormality. Hence, the information can be used for vets to find health related problem about the dog more easily.

In a further embodiment, the user device calculates energy demand of the dog based on the information and other basic information about the dog input by the owner, and provides the owner with a tailored activity plan for the dog based on the energy demand.

For example, the user device may measure e.g., the calories burnt on the dog everyday, the time when the dog was active and the walking distance of the dog. This will help the owner to monitor the dog's activity. Also the owner may input other basic information about the dog including e.g., the dog's breed, age, weight, and gender, then the user device may calculate energy demand of the dog based on the measured information and the input information to calculate energy requirement of the dog, e.g., a Resting Energy Requirement, which is the amount of energy (e.g., calories) a dog needs to maintain basic bodily functions at rest, like breathing and digestion. It's a baseline calculation used to determine a dog's overall daily caloric needs, which may be then adjusted based on factors like activity level and life stage. Using this, the user device may suggest a tailored activity plan for the dog to keep the dog fit and maintain a good health for dog.

In another example, the user device can have a function by which the owner can add the vaccination history of the dog to track the dog's vaccination record and the user device may send a notification for the next vaccine to the owner in time.

In a further embodiment, the server includes an AI model to analyze the dog's emotional status based on the information, wherein the dog's emotional status is sent by the server to the user device and/or the smart collar or harness. For example, the sensor monitors the physiological information of the dog, like respiration, heart beat signal (e.g., from ppg, ultrasound, mm wave, microphone sensors), body temperature, and oxygen level, and using this information and the AI model, the server may be able to analyze different emotions of the dog. These emotions may be sent to and appeared on the user device and then the owner will be able to know what the dog is feeling. These emotions may also be sent to the smart collar or harness for further use, as shown in the embodiment below.

In a further embodiment, the smart collar or harness comprises a microphone and a speaker, and the remote interaction includes that the owner remotely operates the speaker through the user device to talk to the dog, and the smart collar or harness translates the dog's barking response recorded by the microphone into a corresponding text based on the dog's emotion at the moment of the response, and sends the text to the user device via the server for displaying the text to the owner.

For example, the microphone and the speaker may be inside the collar or harness so that owner can talk to the dog and the collar or harness can translate the dog's barking response into a corresponding text. In an example, the owner may ask “are you hungry?”, and if the collar or harness receives emotion like excitement, happiness or similar at the moment of the dog's response, the collar or harness may translate the dog's response into a text “yes”. In an example, the text may be designed to be in a funny way, serious way, or other personality that owner can choose on the user device.

In a further embodiment, the speaker inside the collar or harness can read out the text, in order for the owner to hear the text directly e.g., in the case that the owner is nearby to the dog.

In a further embodiment, the smart collar or harness comprises a location tracker, and the remote interaction includes that the smart collar or harness sends the dog's location information recorded by the location tracker to the user device via the server, in order for the user device to display one or more locations where the dog feels happy and/or unhappy.

For example, a GPS device may be integrated with the smart collar or harness. And the location of the dog may be monitored with the emotion of the dog. For instance, places where the dog is feeling happy and/or unhappy will be marked on the user device and owner will be able to see it e.g., in a map. Hence, the owner will know which places where the dog like and/or dislike. This will help the owner to have better knowledge about his/her pet and provide the pet with a better life.

In an embodiment, the smart collar or harness comprises a microphone and a location tracker, and the remote interaction includes that the smart collar or harness sends the dog's barking recorded by the microphone and the dog's location information recorded by the location tracker to the user device via the server, in order for the user device to display one or more locations with a predetermined number of barks of the dog.

This feature may be used for the dog to find a specific subject. For example, the dog may be trained to find mines, drugs, people, drugs and so on by using the system. In an example, the smart collar or harness has a location tracker such as a GPS device, and once the dog finds the specific subject, the dog can mark the location of the subject on the map by simply barking. The number of barks which may identify different subjects can be predetermined by the owner using the user device. In an example, the user device may also create a region on a map showing a possible scope where the subject is, when the dog makes the predetermined number of barks at several places.

In an embodiment, the smart collar or harness comprises a vibrator, and the remote interaction includes that the smart collar or harness converts the owner's voice or text received from the user device into a vibration which is understandable to the dog and performed by the vibrator, wherein the meaning of the vibration was taught to the dog beforehand by the owner through the user device and the vibrator.

This feature facilitates communication between an owner and his/her dog with hearing impairments. For example, the smart collar or harness may have a vibrator which can vibrate with different frequencies and intensity. And these can be defined by the owner to represent different meanings. The owner may teach the dog what the owner wants to say simply by using the user device and the vibrator. In another example, the smart collar or harness may receive the owner's voice from the user device, and translate the voice to a text and then convert the text into a vibration that dog can understand.

In another example, a separate device that has microphone, camera and speaker in it also will be able to detect the emotion of the dog. Same way as the collar or harness, the camera can monitor the dog's behavior and detect the emotion. Same way can send the detected emotion to the user device of the owner. Also the owner can talk to the dog and the device can translate for the dog.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the disclosure, which are described specifically and in detail, and therefore cannot be construed as a limitation to the patent scope of the disclosure. It should be noted that, a person of ordinary skill in the art may further make variations and improvements without departing from the ideas of the disclosure, which all fall within the protection scope of the disclosure.

It is understood that blocks of the block diagrams and/or flowchart illustrations, and combinations of blocks in the block diagrams and/or flowchart illustrations, may be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

It is also to be understood that the functions/acts noted in the blocks of the flowchart may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Furthermore, the solution of the present disclosure may take the form of a computer program on a memory having computer-usable or computer-readable program code embodied in the medium for use by or in connection with an instruction execution system. In the context of this document, a memory may be any medium that may contain, store, or is adapted to communicate the program for use by or in connection with the instruction execution system, apparatus, or device.

Therefore, the present disclosure also provides a device including a processor and a memory. In the device, the memory stores instructions that when executed by the processor cause the device to perform the method described above with the embodiments and examples.

The present disclosure also provides a machine readable medium (not illustrated) having stored thereon instructions that when executed on a device cause the device to perform the method described with the above embodiments and examples.

Moreover, one or more components/devices in the solution of the present disclosure can be implemented as a network element on a dedicated hardware, as a software instance or a firmware running on a hardware, as a virtualized function instantiated on an appropriate platform (e.g., on a cloud infrastructure), or as any combination thereof.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above-described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure may be defined by the future claims.

What is claimed is:

1. A system for taking care of dog, comprising:
a smart vest, worn on a dog;
a user device, used by owner of the dog for remote interaction with the smart vest; and
a server, communicating with the smart vest and the user device respectively to implement the remote interaction.

2. The system of claim 1, wherein the smart vest comprises one or more physiological information sensors and multiple vibrators, wherein the dog's physiological information monitored by the one or more physiological information sensors is sent by the smart vest to the server for analyzing the dog's emotional status, and the remote interaction includes that the owner sends an instruction to the smart vest through the user device for activating one or more of the vibrators to simulate a hug of the owner, in view of the dog's emotional status received by the user device from the server.

3. The system of claim 2, wherein the server comprises an AI module to analyze the dog's emotional status based on the dog's physiological information.

4. The system of claim 2, wherein the one or more physiological information sensors comprise a heartbeat sensor, and the dog's physiological information comprises the dog's heartbeat information, and the dog's emotional status comprises the dog's anxiety level.

5. The system of claim 2, wherein the smart vest comprises a heartbeat simulator, and the user device comprises a receiver for receiving the owner's heartbeat information from another device, wherein the owner's heartbeat information is sent by the user device to the smart vest via the server, in order for the smart vest to simulate the owner's heartbeat through one of the vibrators or the heartbeat simulator while simulating the hug of the owner.

6. The system of claim 1, wherein the smart vest comprises a speaker, and the remote interaction includes that the owner remotely operates the speaker through the user device to talk to the dog.

7. The system of claim 1, wherein the smart vest comprises a laser pointer and a camera, and the remote interaction includes that the owner remotely operates the laser pointer and the camera through the user device to play the laser point with the dog.

8. The system of claim 1, wherein the smart vest comprises a location tracker, and the remote interaction includes that the smart vest sends the dog's location information recorded by the location tracker to the user device via the server.

9. A system for taking care of dog, comprising:
a smart collar or harness, worn on a dog;
a user device, used by owner of the dog for remote interaction with the smart collar or harness; and
a server, communicating with the smart collar or harness and the user device respectively to implement the remote interaction.

10. The system of claim 9, wherein the smart collar or harness comprises one or more sensors to monitor one or more of the following information: the dog's heart rate, oxygen level, body temperature, barking, activity status, and respiration, and
the remote interaction includes that the smart collar or harness sends the information to the user device via the server.

11. The system of claim 10, wherein the user device notifies the owner of an abnormality in the information in response to detection of the abnormality.

12. The system of claim 10, wherein the user device calculates energy demand of the dog based on the information and other basic information about the dog input by the owner, and provides the owner with a tailored activity plan for the dog based on the energy demand.

13. The system of claim 10, wherein the server includes an AI model to analyze the dog's emotional status based on the information, wherein the dog's emotional status is sent by the server to the user device and/or the smart collar or harness.

14. The system of claim 13, wherein the smart collar or harness comprises a microphone and a speaker, and the remote interaction includes that the owner remotely operates the speaker through the user device to talk to the dog, and the smart collar or harness translates the dog's barking response recorded by the microphone into a corresponding text based on the dog's emotion at the moment of the response, and sends the text to the user device via the server for displaying the text to the owner.

15. The system of claim 14, wherein the speaker inside the collar or harness reads out the text.

16. The system of claim 13, wherein the smart collar or harness comprises a location tracker, and the remote interaction includes that the smart collar or harness sends the dog's location information recorded by the location tracker to the user device via the server, in order for the user device to display one or more locations where the dog feels happy and/or unhappy.

17. The system of claim 9, wherein the smart collar or harness comprises a microphone and a location tracker, and the remote interaction includes that the smart collar or harness sends the dog's barking recorded by the microphone and the dog's location information recorded by the location tracker to the user device via the server, in order for the user device to display one or more locations with a predetermined number of barks of the dog.

18. The system of claim 9, wherein the smart collar or harness comprises a vibrator, and the remote interaction includes that the smart collar or harness converts the owner's voice or text received from the user device into a vibration which is understandable to the dog and performed by the vibrator, wherein the meaning of the vibration was taught to the dog beforehand by the owner through the user device and the vibrator.
